(19) United States
(12) Patent Application Publication
(10) Pub. No.: US 2022/0022696 A1
(43) Pub. Date: Jan. 27, 2022

(54) NOVEL FOOD PREPARATION DEVICE FOR SECURING FOOD ITEMS IN PLACE WHILE COOKING AND THE LIKE

(71) Applicants: Soam Pralhad Desai, Tracy, CA (US); Roma Pralhad Desai, Tracy, CA (US)

(72) Inventors: Soam Pralhad Desai, Tracy, CA (US); Roma Pralhad Desai, Tracy, CA (US)

(73) Assignees: Soam Pralhad Desai, Tracy, CA (US); Roma Pralhad Desai, Tracy, CA (US)

(21) Appl. No.: 17/076,765

(22) Filed: Oct. 21, 2020

Related U.S. Application Data
(60) Provisional application No. 63/056,602, filed on Jul. 25, 2020.

(51) Int. Cl. A47J 43/18

(52) U.S. Cl. CPC A47J 43/18

(57) ABSTRACT

The present invention comprises a novel cooking device generally comprising a long, metal strip at the center with prongs attached to the sides, a hook for vertical hanging, and a handle. Food items of various sizes can be placed on the prongs which are designed to derive heat from the center strip (which acts as a heat channel) and distribute it to the center of the food items. This allows for even heat distribution throughout the entire food item. The prongs are angled to prevent the food items from sliding off. The handle acts as a gap between the heat source and food items when the current invention is hung vertically. It also allows the device to be held during food mounting or removal. The handle also acts as a heat absorber and delivers heat to the center strip. A hook allows the current invention to be hung vertically.

### FIELD OF INVENTION

The present invention relates to novel food preparation devices. More particularly, the invention relates to skewers that are used to hold food items in place for cooking.

### RELATED ART DESCRIPTION

In the world of food preparation, numerous ways exist to secure food during the cooking process, particularly skewers. The use of skewers for cooking has been long known. Traditionally, these skewers are long, wooden or metal sticks with a point on one end. Food is usually cut into pieces, attached to the skewers by pushing the pieces onto the pointed end, and cooked (baking, grilling, etc.). However, there are quite a few drawbacks to the current implementation.

The first drawback with the traditional design is the mediocre heat distribution achieved inside the food items being cooked. Currently, traditional skewers only pierce the food item at one location and allow for pieces to move around along the skewer's length, which may result in the pieces touching each other or clumping together. This reduces or prevents heat exposure and heat absorption of the metal skewer and reduces or prevents the heating of the food items from within. Because of this, the cooking of the food items from the inside is not achieved as effectively. If food items touch each other, there is less area of the skewer exposed to the heat. This results in a lower rate of cooking inside the food items than outside which may leave food items undercooked or uncooked. If the food items are heated from outside long enough for the temperature inside to reach cooking temperatures, this may result in food items being overcooked on the outside. Overall, the cooking result is unpredictable, and consistency is difficult to achieve.

Another drawback resulting from the uneven heat distribution is excessive fuel used and a longer cooking time. Due to slow heat distribution offered by the current implementation, food items need to be cooked much longer. As a result, much more energy is needed to cook the food items and it takes longer for the user to cook the food items.

Another drawback of the current design in the inability to use skewers in a vertical setting. Most designs offer no mechanism to hang the skewer to cook vertically. The common design is usually a simple stick. While some implementations with a circle or other mechanism at the end for hanging do exist (US Patent #20050200141A1) they still have many other drawbacks. This design is still prone to the heat distribution and excessive resource use problems as described above.

Additionally, there is another problem; for the traditional skewers that do have a mechanism to hang vertically, they still however result in reduced cooking quality when used in a vertical cooking setting as opposed to the usually horizontal cooking setting. When the traditional skewer is hung vertically, all the food items are pulled down and stick together due to the force of gravity. Pieces sticking together prevent heat from reaching all parts resulting in uneven cooking. If different types of food are placed, the pushed together pieces mix flavors and reduce overall food quality.

Now while some solutions do exist, they have their own set of drawbacks as well. Skewers with multiple spokes (U.S. Pat. No. 2,557,890A), may hold food together better than the traditional skewer; but, this skewer too has its own set of limitations. The above referenced skewer is specifically designed for cooking rolled meat products and cannot support a wide range of food items which is a huge downside. Since the rolled meat covers the entire length of the skewer, it too suffers from the same heat distribution issues. This skewer also could not be placed vertically since there is no mechanism to hang. In addition, another downside of this implementation is the ability to clean the cooking device with ease. The spokes make the cleaning process and food removal process difficult and dangerous as there is a threat of hands being impaled by the spokes.

Some solutions do try to fix the cleaning and food removal problem mentioned above but do so with limited success. U.S. Pat. No. 6,286,418B1 describes a rod-like skewer with a handle at the end along with a barrel like clamping device which is used to easily remove food items from the skewer and clean it at the same time. While it can easily clean skewers and remove food items after cooking in theory, this is not so in practice. Cooked food items typically stick to the skewer during the cooking process. Removing the entire skewer length of food by sliding the food out at one end by pressing at the other end using the clamp results in food items being pressed against each other causing damage and breaking up of the food itself. The food towards the top end of the skewer (last pieces to fall off of the skewer) will fare the worst since these food items will be pressed by the clamp the most to pressure the rest of food items off of the skewer. The above design also suffers from the same lack of heat distribution, time/fuel efficiency, and the vertical cooking problem mentioned above which makes it not viable for consumers looking for such features.

Finally, many traditional skewers lack a handle. As a result, the traditional skewer design may cause the skewer to become difficult to hold by not providing enough area for the user to hold onto the skewer. Now while some solutions with handles do exist (U.S. Pat. No. 6,286,418B1) it still suffers from many of the problems mentioned above such as heat distribution, resource wastage and inability to hang vertically for vertical cooking.

Solutions do not exist that solve all the problems mentioned above. Therefore, a need exists for a skewer that is capable of distributing heat evenly throughout food items and preserving time/energy efficiency. A need also exists for a skewer that has the ability to be hung vertically and provides the same quality of cooking regardless of vertical or horizontal cooking. Finally, a need exists for allowing any sized food items, providing a safe and easy way of cleaning/removing food and offering an easy way to hold the skewer.

### BRIEF SUMMARY

The present invention comprises a novel cooking device generally consisting of a long, flat, wide strip of metal at the center with a plurality of rib-like prongs attached to each of the sides of the center strip, a hook for vertical hanging, and a designated handle. Food items are attached on to the prongs on the side.

A plurality of prongs that are close together are designed to pierce food items in a plurality of places. This also keeps food items secured and prevents sliding or clumping. The prong spacing and number of prongs is designed to allow any sized food item to be placed. The prongs are also angled to prevent the food from falling off in a vertical or horizontal setting. The prongs are spaced apart evenly while making sure spacing between the prongs is slightly larger than the prongs themselves. This allows for easily removing food items once they are cooked and cleaning food debris off the prongs by inserting prongs of two copies of the present invention into each other and using a back and forth motion.

The center strip of the present invention provides a wide heat channel where heat can be transferred to the prongs and eventually to the center of food items. Each food item is pierced by a plurality of prongs. This allows for even heat distribution and better cooking as there are a plurality of locations in which heat is being transferred to the center of the food item. This design also allows for faster cooking than traditional skewers which can save fuel from the cooking source. At one end of the present invention, a hook-like structure is provided which allows for vertical hanging; however, the current embodiment is designed for placing and cooking in a horizontal position as well. The current invention also comprises a structure at one end to serve as a handle as well as to provide some distance from the heat source when used in a vertical setting. This distance ensures food items will not directly come into contact with the heat source and ensures even heating.

### DRAWINGS BRIEF DESCRIPTION

The figures included serve as examples of some embodiments of the present invention. The present invention is not limited by the figures depicted in the drawings.

FIG. 1 depicts an example of an angled side view according to various embodiments of the present invention.

FIG. 2 depicts an example front view according to various embodiments of the present invention.

FIG. 3 depicts an example of a close-up view of the rib-like structure on the present invention according to various embodiments of the present invention.

FIG. 4 depicts an example of a close-up view of the spoke-like prongs on the present invention according to various embodiments of the present invention.

FIG. 5 depicts an example of a close-up view of the upper region of the present invention according to various embodiments of the present invention.

### DETAILED DESCRIPTION

The terminology used herein is for the purpose of describing different embodiments only and is not intended to limit the invention. The words “and/or” include all combinations of one or more of the associated listed items. As used herein, the singular forms “a,” “an,” and “the” are meant to incorporate the plural forms and the singular forms, unless stated otherwise. Also, the words “comprises” and/or “comprising,” specify the presence of the stated elements, but do not exclude other elements not stated. Unless otherwise defined, all terms used herein have the same meaning as usually understood by one having ordinary skill in the art to which this invention belongs.

In describing the invention, the steps and techniques are disclosed. Each of these steps and techniques have individual benefits but can also be used with one or more, or in some cases all, of the other steps and techniques acknowledged. For the sake of clarity, this description will not repeat every possible combination of the individual steps unnecessarily. However, it must be understood that such combinations are entirely within the scope of the invention and the claims.

New skewering devices are discussed herein. For the purpose of explanation, in the following description multiple details are expressed in order to provide an accurate perception of the present invention. It will be clear, however, to one skilled in the art that the present invention may be used without these specific details. The present disclosure is to be considered as an example of the invention and is not intended to limit the invention to the specific embodiments described below. The present invention will now be discussed and explained further by referencing the attached images below. For the sake of brevity, the present invention may be referred to as “the device” in some places throughout the rest of the description.

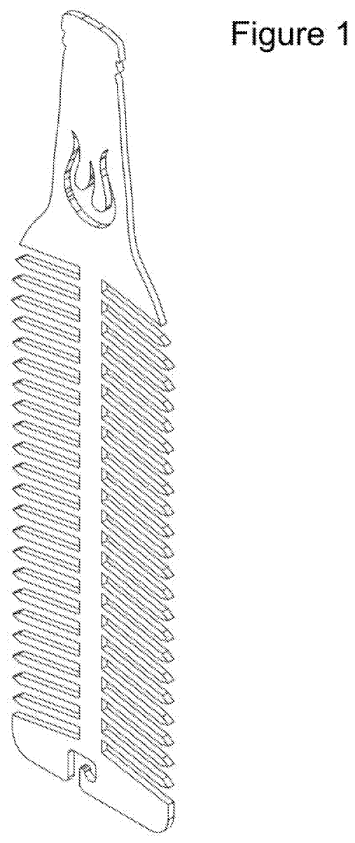

FIG. 1 illustrates an angled side view perspective of the preferred embodiment. The preferred embodiment is made out of 2.5 mm thick stainless steel but can also be made of, but not limited to: steel, aluminum or other suitable metals or materials. The preferred embodiment is cut out of sheet metal however other processes can be used to acquire the desired shape such as, but not limited to die casting, milling, or any other metal or material fabrication method. The device has a total length of about 300 mm however it is not limited to this length only. Being made out of stainless steel allows the device to keep its strength and form after repeated heating and cooling cycles. The device material thickness of 2.5 mm makes it so that the device will not bend, twist, or deform during use but will still provide adequate strength and support. The material choice also allows heat conduction to occur throughout the device.

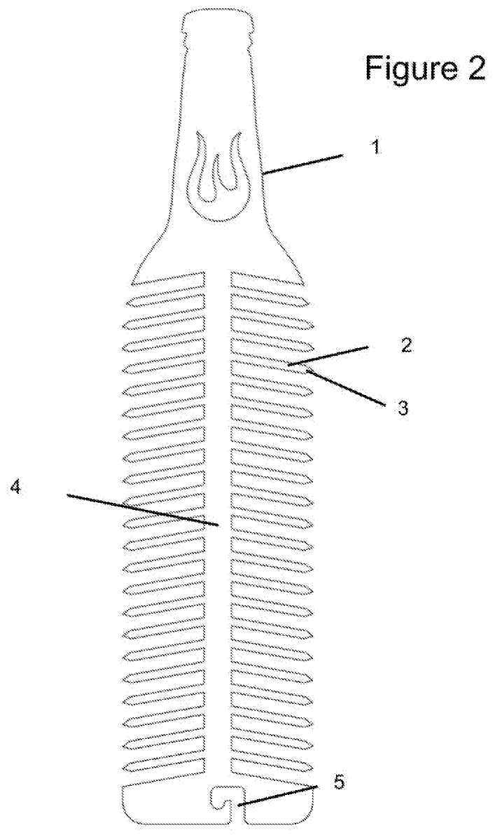

FIG. 2 illustrates what one prong 2 of the device looks like. It is a rectangular body with a pointed tip 3 however it is not limited to this shape. Alternative embodiments could include rounded rectangles, ovals, or any other shape used to create a prong-like piece. In alternative embodiments, the pointed tip 3 may also be a different shape or not be pointed at all.

The preferred embodiment has 3 mm wide prongs 2 spaced evenly at 5 mm apart along the length of the center metal strip. The prongs 2 are about 30 mm long (with some potentially shorter) to match the bottle design shape. The prongs 2 are tilted towards the hook 5 structure at an angle of 10 degrees from the horizontal position. The above measurements are simply for the preferred embodiment but are not only limited to these. A combination of other prong lengths, widths, and spacings can be used to create an alternative embodiment.

FIG. 2 illustrates what the center heat channel strip 4 looks like. It is rectangular in shape and is approximately 10 mm in width and approximately 184 mm in length in the preferred embodiment. Like the rest of the device, the center heat channel strip 4 (‘the center strip’) is 2.5 mm thick in the preferred embodiment. These are only dimensions for the preferred embodiment and alternative embodiments may include a range of different dimensions and shapes. The center strip 4 acts as a connector for the prongs 2. The prongs 2 are connected on the sides of the center strip 4. The center strip's length allows it to hold the total number of prongs 2 required. In the preferred embodiment, the center strip 4 holds twenty-two prongs 2 on each side and are evenly spaced along the center strip 4. Alternative embodiments may include more or less no or prongs 2 with even or uneven spacing between them.

Currently, a food item will be placed onto the device by being skewered onto a plurality of prongs 2. These prongs 2 piercing a single food item will improve heat distribution since the center strip 4 acts as a heat channel. When the device is heated, the center strip 4 is heated as well. The center strip's width allows it to transfer heat efficiently to the prongs 2 and eventually to the center of the food items. This allows for the even distribution of heat inside the food item as there are a plurality of prongs 2 buried within each food item. This prevents food from being overcooked on the outside while being undercooked or uncooked on the inside. Also, because there is a plurality of heat distribution points inside the food, food items will cook faster which in turn saves user's time and energy from the heat source.

In addition, the width and spacing of the prongs 2 allows a plurality of prongs 2 to pierce a single piece of food. This forces the food item to be held in place and prevents sliding even if the device is moving. The plurality of points of contact create stability. The food items staying in place and not touching other food items results in a higher quality of cooking. If different food items touch each other, they may exchange flavors and ruin the quality. In addition, food that is apart from each other ensures that the heat can surround the entire piece and can cook each food piece thoroughly.

Another reason for the prong 2 width and spacing is to accommodate all types of food item sizes. Since the prongs 2 are close together, many different sized food items can be attached. The prong 2 placement on the device allows for the user to observe how large their food item is and choose the correct number of prongs 2 to fully fit the food piece onto the device. Varying the food item size will result in more or less prongs 2 being used by a single item.

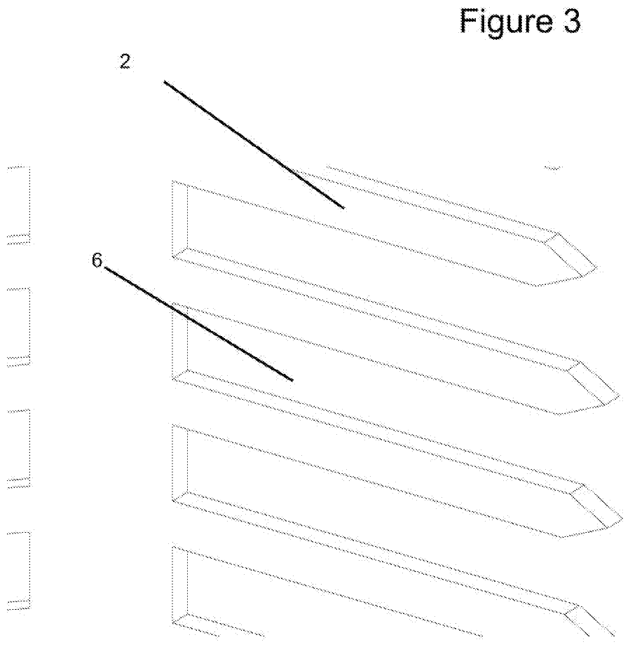

In addition, the width and spacing between the prongs 2 also allows for easily removing food items once they are cooked from the device. FIG. 3 shows the prongs 2 and the gaps 6 between them. Since the 3 mm wide prongs 2 can fit in the 5 mm wide gaps 6 between prongs 2, two devices can be used together to remove food items off of each other. Interlocking two devices and then sliding one across the prongs 2 of the other will remove the food items. This is designed so users do not have to get their hands dirty or contaminate the food with their hands while removing the food items. This design also allows for the easy cleaning of the device. The device can easily be cleaned by interlocking two devices and then moving them in a back and forth motion to clean off any remaining food debris.

As shown in FIG. 2, in addition to the prong 2 spacing, the prongs 2 are also mounted at a 10-degree angle from the horizontal position towards the hook 5 structure so that they are facing away from the neck 1 of the device. The prevents food items from sliding off the prongs 2 when being a user holds the handle and puts food items onto the device. This also prevents food items from falling off when the device is used in a vertical cooking setting with the hook 5 facing up and the neck 1 of the device facing down. This is beneficial when the device is used or held in a vertical setting however the device may also be used in a horizontal setting. The preferred embodiment has the prongs 2 at a 10-degree angle from the horizontal, pointed towards the hook 5 but alternative embodiments could increase or decrease this prong 2 angle.

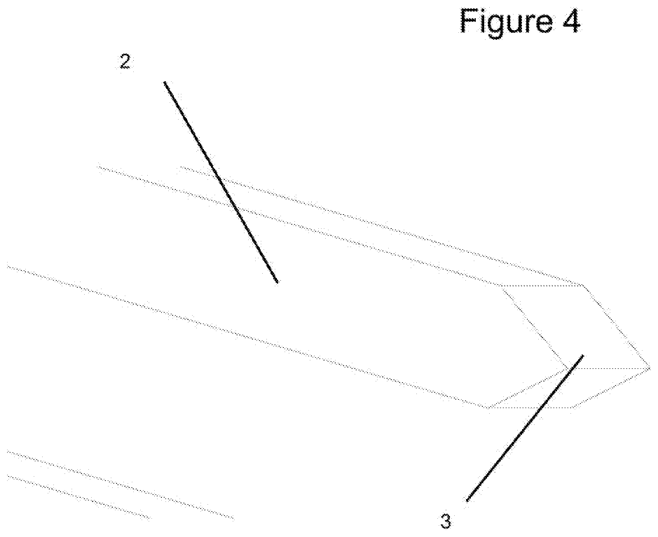

As shown in FIG. 4, the ends of each prong 2 have a pointed tip 3. The pointed tip 3 forms from a triangular shape at the end of the prong 2. Approximately 3.4 millimeters from the outer edge of the prong 2, material is cut away at an angle from both sides of the prong 2 so that the material forms a point. In the preferred embodiment, the pointed tip 3 is of a triangular shape but alternative embodiments could include curved, squarish, circular or any other suitably shaped tips. This structure makes it easy to pierce and put food items onto the prongs 2. The pointed tip 3 allows food items to easily slide onto the device prongs 2. This structure also prevents damage to the food item since the pointed tip 3 glides into the food with limited friction.

FIG. 2 illustrates the hook 5 at the end of the device in the preferred embodiment. The hook 5 allows the device to be hung in a vertical direction; however, the device can also be placed in a horizontal direction. While the preferred embodiment comprises a hook 5 with the illustrated shape and size, alternative embodiments could vary the size, shape, and location of the hook 5 or not contain a hook 5 at all.

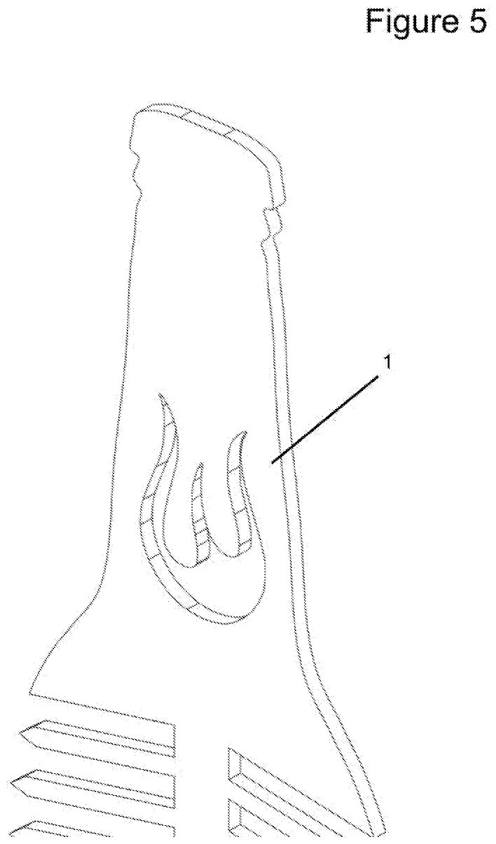

FIG. 5 illustrates what the neck 1 of the device looks like. The neck 1 is about 97 mm long but alternative embodiments could include any other length. The neck 1 serves as a handle for the device. It gives users an easy way to hold the device while food items are being placed on, removed, or when the device is being cleaned. In addition, the thin to wide handle design is created to act as a heat absorber when the device is used in a vertical setting. The neck 1 section absorbs heat and delivers it to the center heat channel strip 4. This heat then continues to the prongs 2 and into the food items as described previously above. The length, thickness, and width of the handle in the preferred embodiment serve to provide users with an easy, intuitive handle feel while providing the optimal area to absorb heat; but alternative embodiments could include varying length, thickness and width of the handle section.

In addition to serving as a handle, the neck 1 forces the food items to maintain a certain distance from the heat source when used in a vertical setting. This prevents the overcooking or burning of food items when the device is hung vertically. When the device is hung vertically, there will be food items that are closer to the heat source at the bottom. Without a neck 1 section, the food pieces may end up being very close to the heat source. This means that food closer to (or even inside) the heat source will be exposed to higher temperatures than the rest of the food items and cook faster or burn. To prevent the uneven heating, the 97 mm long neck 1 extension leaves space between the heat source and the food items so all the food items cook evenly.

We claim:

1. An apparatus for securing and holding food items, comprising an elongated neck connected to a center strip, where said center strip portion comprises a plurality of angled prongs attached on both sides of said center strip where said prongs run the length of said center strip, where said center strip has a hook.

2. The apparatus of claim 1 wherein said elongated sloped neck acts as a separation between said food items and a heat source when said apparatus is placed vertically.

3. The apparatus of claim 1 wherein said elongated neck acts as a handle to hold said apparatus.

4. The apparatus of claim 1 wherein said center strip is wide and long enough to act as a heat channel to transfer more heat to said food items faster.

5. The apparatus of claim 1 wherein said angled prongs increase heat distribution to the center of said food items by piercing and conducting heat to said food items in a plurality of places.

6. The apparatus of claim 1 wherein said angled prongs comprise of an angled protrusion from said center strip, ending with a pointed tip, where said angled prongs are of enough size to secure food items in a plurality of places and inhibit said food items from sliding off said apparatus in a horizontal or vertical setting.

7. The apparatus of claim 1 wherein said angled prongs are spaced appropriately so that food items of different sizes, small or large can be hung on said angled prongs.

8. The apparatus of claim 1 wherein said angled prongs are spaced appropriately so that the prongs of one apparatus can be used to remove food items off another apparatus.

9. The apparatus of claim 1 wherein said angled prongs are spaced appropriately so that the prongs of one apparatus can clean the prongs of another apparatus.

10. The apparatus prongs of claim 2 where said pointed tip allows for an easier time to put said food items onto said angled prongs.

11. The apparatus of claim 1 wherein said hook allows said apparatus to be hung in a vertical direction.
